(19) United States
(12) Patent Application Publication
(10) Pub. No.: US 2012/0304016 A1
(43) Pub. Date: Nov. 29, 2012

(54) STORAGE CONTROL DEVICE, STORAGE DEVICE, AND DIAGNOSTIC METHOD

(75) Inventor: TAKASHI FUJIHARA, KAWASAKI (JP)

(73) Assignee: FUJITSU LIMITED, KAWASAKI-SHI (JP)

(21) Appl. No.: 13/429,711

(22) Filed: Mar. 26, 2012

(30) Foreign Application Priority Data
May 25, 2011 (JP) 2011-116461

(51) Int. Cl. G06F 11/16

(52) U.S. Cl. 714/42; 714/E11.056

(57) ABSTRACT

A storage control device includes an interface for a host computer and a memory device and a control unit that creates a read command that causes the memory device to reproduce data at an access target address, and creates a first diagnosis command that causes the memory device to conduct a diagnostic reproduction at an address subsequent to the access target address, according to the request received from the host computer, sequentially issues the read command and the first diagnosis command to cause the memory devices to execute sequential accessing and conducts a diagnosis to confirm the normality of the memory device.

CROSS-REFERENCE TO RELATED APPLICATION(S)

This application is based upon and claims the benefit of priority of the prior Japanese Patent Application No. 2011-116461, filed on May 25, 2011, the entire contents of which are incorporated herein by reference.

### FIELD

The embodiment disclosed herein relates to a storage control device, a storage device, and a diagnostic method.

### BACKGROUND

A Redundant Arrays of Inexpensive Disks (RAID) device is well known in the art as a storage device that handles a plurality of hard disk drives (HDD) as one logical volume.

Storage devices such as a RAID device are connected through a network to a host computer such as a personal computer or a server. A controller of a storage device implements recording and reproduction control and the like of data on the HDDs when an input or an output request (I/O request) such as a data recording or reproduction request issued by the host computer is received.

Since the RAID device uses a plurality of HDDS, failures occur in hard disk media that are a memory media mounted in the HDDs. These failures arise from damage to the hard disk media or deterioration of the magnetic film of the hard disk media, or a reduction in performance dependent on the operating environment, and thus can lead to recording or reproduction errors.

As a result, the HDDs of the RAID device have a redundant configuration and are provided with a rebuilding function to rebuild data of failed hard disks in the RAID device. Therefore, when a failure in a certain HDD hard disk medium is detected, the data of the failed hard disk medium can be recovered and the data can be rebuilt using other HDD data in the redundant configuration. The rebuilt data is recorded in a spare HDD or in a logic block address of a separate HDD belonging to the failed medium.

However, failures of a hard disk medium may include synchronous errors that can be detected at the timing of the failure. Conversely, failures may also include asynchronous errors that can be detected at a timing of accessing a hard disk medium but might not be detected at the timing of the failure.

For example, an error is not detected without accessing a certain Logical Block Address (LBA) when recording or reproducing is impossible at that LBA.

As a result, the RAID device has a function to conduct a patrol diagnosis (disk patrol) whether or not an I/O request is received from the host computer. This function includes reproducing the data applicable to the range of the entire volume of all the HDDs of the RAID device to check for the existence of failures of the hard disk media. This function is called a patrol diagnosis (disk patrol).

In patrol diagnosis, all the storage regions (the range of the entire recordable volume of data) of the HDDs are reproduced from the starting logical block address (starting LBA) to the final logical block address (final LBA) in the address order to detect errors.

A controller of the RAID device issues patrol diagnosis commands to each HDD to cause the HDDs to implement the patrol diagnosis, and then receives error detection results from the HDDs. The RAID device controller determines the presence or absence of failures on the hard disk media of the HDDs based on the error detection results and confirms the normality of the hard disk media.

The abovementioned patrol diagnosis is implemented at certain intervals in certain areas of the hard disk media so as not to affect input/output processing (hereinbelow, referred to as I/O processing) of the data subject to the input/output requests from the host computer. As a result, it takes a very long time to complete the patrol diagnosis of the entire volume range of all the HDDs of the RAID device.

Even when diagnosis commands for executing the patrol diagnosis are issued, for example, every 1 to 2 seconds, if the total volume of all the HDDs is several terabytes, it will take several months to complete the patrol diagnosis of the range of the entire volume of the HDDs.

Moreover, LBA ranges that have not undergone patrol diagnosis for a long time are generated due to the sequential order of the execution of the patrol diagnosis. When an unrecoverable error occurs in a range of LBAs waiting for the execution of the patrol diagnosis in this way, an irreparable error might not be noticed until an I/O request for that LBA range is issued. Therefore, failures in HDD hard disk media might not be detected at an early stage.

Additionally, since the patrol diagnosis is executed in synchronization between a plurality of HDDs, there is a high possibility that the patrol diagnosis of the entire volume range of redundant HDDs might not be completed and so there is a high possibility that similar errors may occur in the HDDs belonging to the failed hard disk media.

As a result, it is conceivable that the HDDs might not be rebuilt when errors also occur in the redundant HDD hard disk media. Therefore, it is desirable to effectively execute the patrol diagnosis as early as possible.

### SUMMARY

According to an aspect of the invention, a storage control device includes an interface for a host computer and a memory device and a control unit that creates a read command that causes the memory device to reproduce data at an access target address, and creates a first diagnosis command that causes the memory device to conduct a diagnostic reproduction at an address subsequent to the access target address, according to the request received from the host computer, sequentially issues the read command and the first diagnosis command to cause the memory devices to execute sequential accessing and conducts a diagnosis to confirm the normality of the memory device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of a storage system.

FIG. 2 illustrates a regular patrol diagnosis.

FIGS. 3A and 3B illustrate examples of tables for patrol diagnosis.

FIG. 4 illustrates a regular patrol diagnosis control flow.

FIG. 5 is a first explanation of a patrol diagnosis during I/O processing.

FIG. 6 is a second explanation of the patrol diagnosis during I/O processing.

FIG. 7 illustrates a control flow of a patrol diagnosis during I/O processing.

### DESCRIPTION OF EMBODIMENT

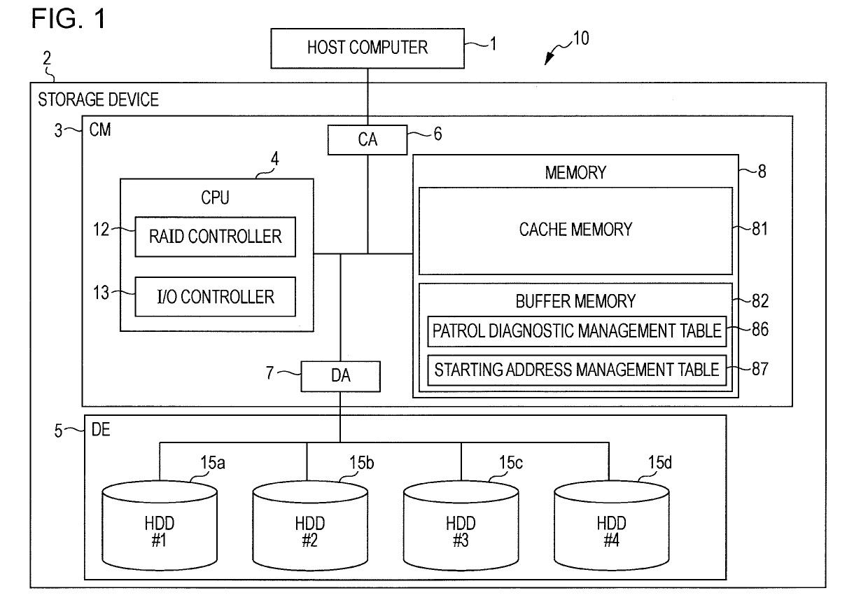

In the following description, an embodiment will be described in detail with reference to the drawings. FIG. 1 describes a configuration of a storage system. In FIG. 1, a storage system 10 includes a host computer 1 and a storage device 2. The host computer 1 is a host device that requests the storage device 2 to record and reproduce data.

The storage device 2 includes a controller module (CM) 3 that is an example of a storage control device, and a disk enclosure (DE) 5. The storage device 2 conducts the recording and reproducing of data by instructing the device enclosure (DE) 5 according to requests from the host computer 1 to record or reproduce data.

The device enclosure (DE) 5 is equipped with a plurality of memory devices 15a to 15d. Examples of memory devices include hard disk devices (HDD) and solid state drives (SSD).

In FIG. 1, four hard disk devices (HDD #01 to HDD #04) are included as memory devices in the device enclosure (DE) 5. The storage device 2 is configured as a RAID device. The storage device 2 may also be equipped with SSDs in addition to the plurality of HDDs.

The controller module 3 includes a controller (CPU) 4, a channel adapter (CA) 6 for establishing an interface connection with the host computer 1, a device adapter (DA) 7 for establishing an interface connection with the device enclosure 5, and a memory 8. The CPU 4 executes various programs. The CPU 4 functions as a RAID controller 12 and an input/output controller (I/O controller) 13 by executing programs.

The memory 8 is used as a cache memory 81 and a buffer memory 82. The cache memory 81 is a memory that temporarily stores data for transferring the data between the host computer 1 and the device enclosure 5.

The buffer memory 82 is a memory that stores various programs and various management tables used by the CPU 4. Moreover, patrol diagnosis tables such as a patrol diagnosis management table 86 and a starting address management table 87 and the like are stored in the buffer memory 82.

The RAID controller 12 conducts RAID control using a RAID redundant configuration on the device enclosure 5 that forms one RAID group with the plurality of memory devices 15a to 15d. The RAID controller 12 temporarily stores data transferred from the host computer 1 in the cache memory 81.

The RAID controller 12 also conducts processing so that the data transferred from the host computer 1 can be stored in the memory devices 15a to 15d, and sends an instruction to the I/O controller 13 to issue various commands to the memory devices 15a to 15d.

The I/O controller 13 conducts input/output commands to transfer data from the cache memory 81 to the device enclosure 5, and to transfer data from the device enclosure 5 to the cache memory 81.

The I/O controller 13 receives instructions from the RAID controller 12 to issue host request input/output commands for conducting the recording or reproduction of data, to the memory devices 15a to 15d in the DE 5. The memory devices 15a to 15d receive the host request input/output commands via the DA 7, and conduct I/O processing such as data recording and reproduction according to the commands.

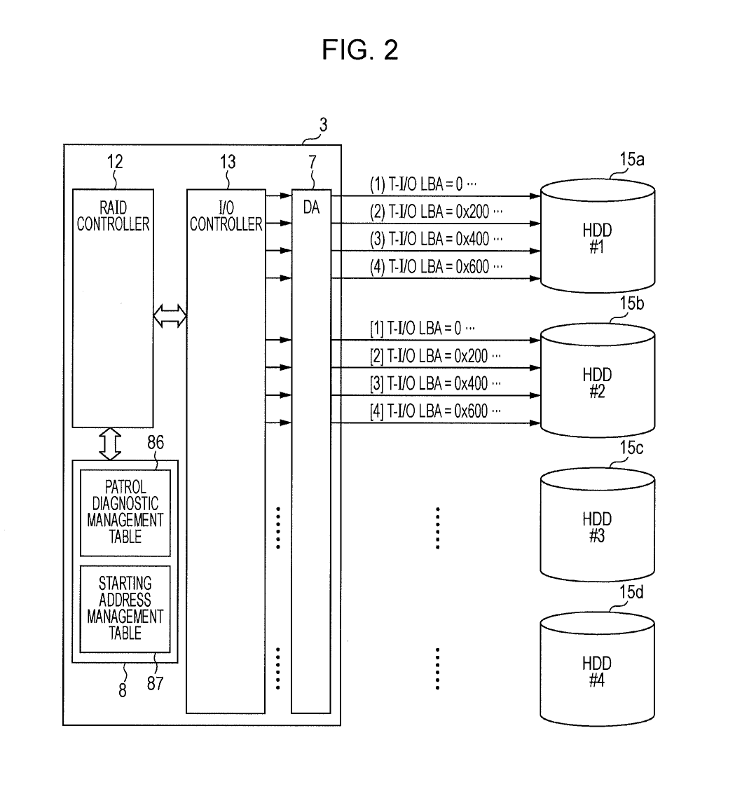

FIG. 2 illustrates a regular patrol diagnosis and schematically describes controlling when a patrol diagnosis is implemented periodically at certain time periods (regular patrol diagnosis). The I/O controller 13 receives instructions from the RAID controller 12 to regularly (for example, every 2 seconds) issue a first diagnosis command (regular patrol diagnosis command).

The I/O controller 13 then executes a patrol diagnosis on the HDDs #1 to #4 that are the respective memory devices 15a to 15d. Therefore, the first diagnosis command is issued at a certain timing regardless of the host request input/output commands.

A certain amount of time is taken to execute one patrol diagnosis from the starting logical block address (starting LBA) until the final logical block address (final LBA) in all the data storage regions of the HDDs #1 to #4. Therefore, a response to an I/O request from the host computer 1 might not be given for a long period of time.

Thus, the RAID controller 12 and the I/O controller 13 previously divide all the data storage regions of the HDDs #1 to #4 into a plurality of areas for patrol diagnosis and manage the areas as patrol diagnosis areas.

A patrol diagnosis area is a data storage region specified by a plurality of successive logical block addresses. The RAID controller 12 and the I/O controller 13 execute the patrol diagnoses in order in each area from the starting area until the final area of the HDDs #1 to #4.

The size of one area depends upon the time (patrol diagnosis execution time) to be spent for executing the patrol diagnosis in that area. Therefore, the patrol diagnosis execution time is set to fall within the range of a timeout time period set by the host computer 1, and the size of each area is previously set accordingly.

The RAID controller 12 refers to the patrol diagnosis management table 86 and the starting address management table 87 at the certain patrol timing. The RAID controller 12 acknowledges patrol diagnosis execution conditions, logical block addresses, and starting addresses in the patrol diagnosis areas of the HDDs #1 to #4, and sends a patrol diagnosis execution instruction to the I/O controller 13.

As illustrated in FIG. 2, the I/O controller 13 receives the instruction from the RAID controller 12 and executes a patrol diagnosis of a range of logical block addresses from LBA 0 to LBA 0x7FF of a patrol diagnosis area (area 1). In the example illustrated in FIG. 2, the range of the LBA 0 to LBA 0x7FF is divided into four to specify addresses.

A plurality of first diagnosis commands (T-I/O commands) (1) to (4) are sequentially issued that instruct the HDD #1 that is the memory device 15a to conduct a diagnostic reproduction. The I/O controller 13 also executes a patrol diagnosis of the range of logical block addresses LBA 0 to LBA 0x7FF at the same time on the HDD #2 that is the memory device 15b.

Specifically, a plurality of first commands (T-I/O commands) [1] to [4] are sequentially issued to the HDD #2. Similarly, the plurality of first commands are sequentially issued to the HDD #3 and the HDD #4 that are respectively the memory device 15c and the memory device 15d, to execute the patrol diagnosis.

The memory devices 15a to 15d receive the first diagnosis commands and conduct diagnostic reproduction of the logical block addresses applicable to the patrol diagnosis. The diagnostic reproduction is a reproduction process in which data (recorded data) recorded in the hard disk media of the memory device is reproduced, CRC and the like is used to test whether or not the data is reproduced correctly, and the test results are sent to the host computer 1.

The data reproduced in the diagnostic reproduction based on the first diagnosis command and a second diagnostic command is discarded without being transferred to the cache memory 81 after the testing. The RAID controller 12 acknowledges whether or not there are any irreparable errors and determines the presence or absence of failures on the hard disk media of the HDDs based on the testing results, and confirms the normality of the hard disk media.

If the RAID controller 12 determines that data rebuilding is desired, the RAID controller 12 reproduces the data from the memory device made redundant with the HDD that belongs to the failed hard disk medium to rebuild the data. The rebuilt data is recorded on another block of the HDD or on a spare HDD.

In this way, the patrol diagnosis is sequentially executed in each patrol diagnosis area at a certain patrol timing up to the final LBA of all the memory devices (HDDs #1 to #4).

The patrol diagnosis may also be executed on a data storage region specified with one or more successive logical block addresses that continue from the front and/or back of logical block addresses subject to accessing without setting the patrol diagnosis area as described above.

Specifically, the number of blocks to undergo patrol diagnosis may also be decided beforehand so that the RAID controller 12 may determine, from the number of blocks, a patrol diagnosis target according to the logical block addresses subject to accessing such that the I/O controller 13 may create diagnosis commands based on the patrol diagnosis target.

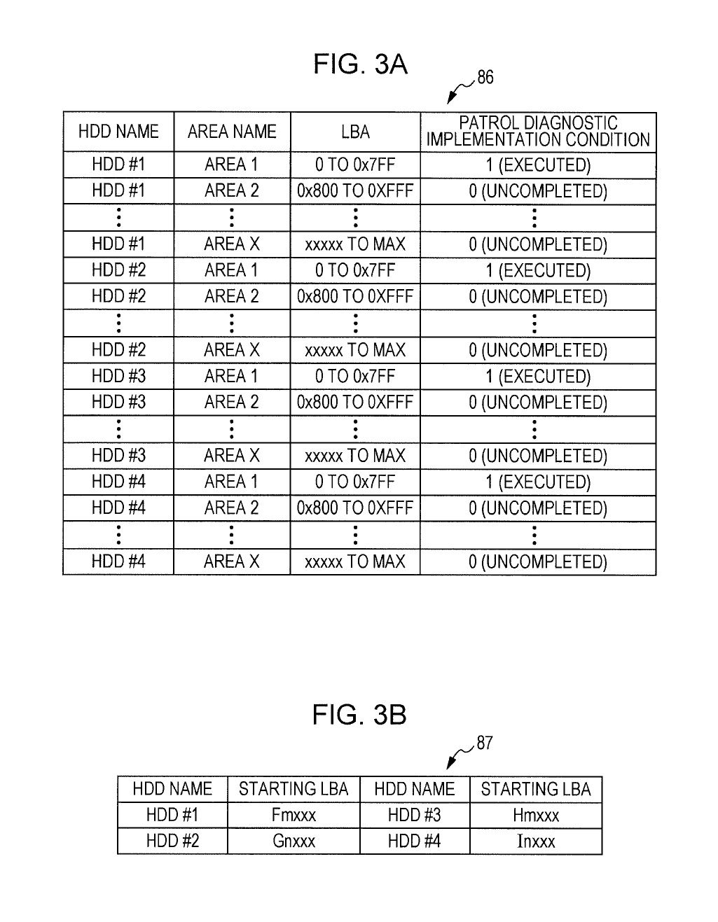

FIGS. 3A and 3B illustrate examples of tables for patrol diagnosis. FIG. 3A describes an example of the patrol diagnosis management table 86. The patrol diagnosis management table 86 includes an HDD name, an area name of the patrol diagnosis area, a logical block address (LBA) of the patrol diagnosis area, and patrol diagnosis execution conditions.

Flags assigned a value “1,” which indicates that the patrol diagnosis has been executed, or “0,” which indicates that the patrol diagnosis has not been completed, are recorded in the patrol diagnosis execution condition column. Moreover, tables may be provided for each patrol diagnosis area and flags may be provided for each logical block address that belongs to the patrol diagnosis area.

FIG. 3B describes an example of the starting address management table 87. A starting logical block address (starting LBA) on which the patrol diagnosis is started in each HDD is recorded therein. The starting LBA is updated each time a patrol diagnosis is executed.

The RAID controller 12 refers to the patrol diagnosis management table 86 to find the patrol diagnosis area to which the starting LBA belongs. The patrol diagnosis is executed from the starting LBA to the final LBA in the found patrol diagnosis area.

Specifically, since the starting LBA is not updated if the patrol diagnosis is interrupted before reaching the final LBA in one patrol diagnosis area, the patrol diagnosis is able to be re-executed on the same patrol diagnosis area. Consequently, patrol diagnoses for all the LBAs may be reliably executed.

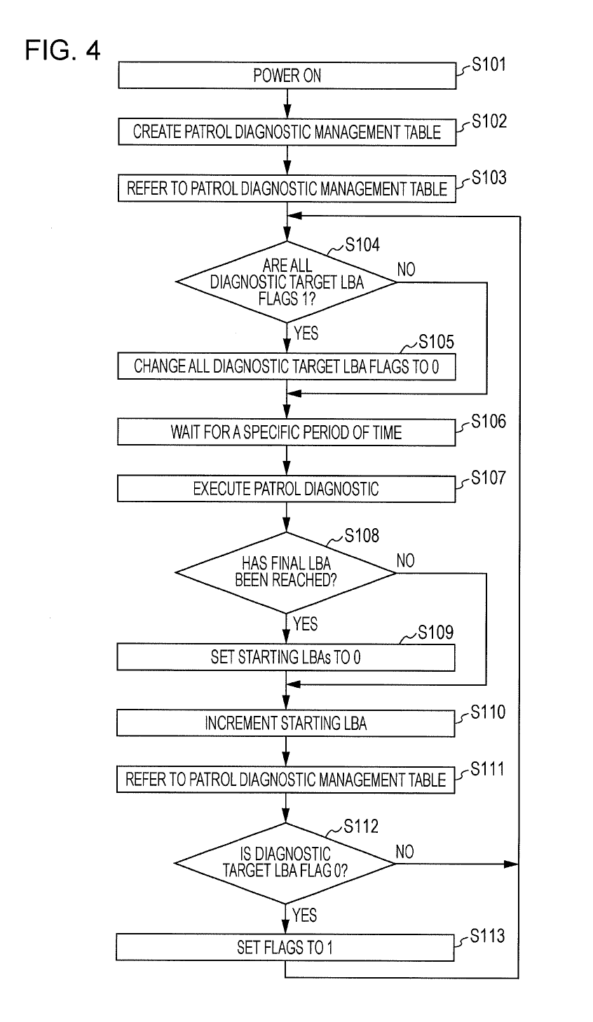

FIG. 4 illustrates a regular patrol diagnosis control flow. In S101, the power is turned on in each of the HDDs #1 to #4 that are the respective memory devices 15a to 15d. In S102, the RAID controller 12 creates the patrol diagnosis management table 86. In S103, the RAID controller 12 refers to the patrol diagnosis management table 86.

In S104, the RAID controller 12 determines whether or not the flags that indicate the patrol diagnosis execution conditions for all the logical block addresses (all diagnosis target LBAs) of the diagnosis target HDD (for example, HDD #1) are all “1” (executed).

If the flags all state “1” (S104: Yes), the RAID controller 12 has completed the execution of the patrol diagnosis for all the logical block addresses of the diagnosis target HDD. Therefore, in S105, the I/O controller 13 changes the flags of all the diagnosis target LBAs to “0” (uncompleted). If a flag indicates that the patrol diagnosis has not been completed (S104: No), the processing advances to S106.

In S106, the processing waits for a certain period of time (for example, 2 seconds). In S107, the RAID controller 12 searches for the patrol diagnosis area containing the starting logical block address (starting LBA) recorded in the patrol diagnosis management table 86 and the starting address management table 87. The RAID controller 12 instructs the I/O controller 13 to execute the patrol diagnosis in the found patrol diagnosis area from the starting LBA to the final LBA.

If the final logical block address (final LBA) of all the data storage regions is reached as a result of the executed patrol diagnosis (S108: Yes), the RAID controller 12 then sets the starting LBAs in the starting address management table 87 to “0” in S109.

If the patrol diagnosis does not reach the final LBA (S108: No), the processing advances to S110. In S110, the RAID controller 12 increments the starting LBAs in the starting address management table 87.

In S111, the RAID controller 12 refers to the patrol diagnosis management table 86. If there are flags of the logical block addresses that have been diagnosed by the patrol diagnosis indicating “0” (uncompleted) in the patrol diagnosis management table 86 (S112: Yes), the RAID controller 12 sets the flags to “1” (executed) in S113. If there are no flags indicating “0” (S112: No), the processing returns to S104.

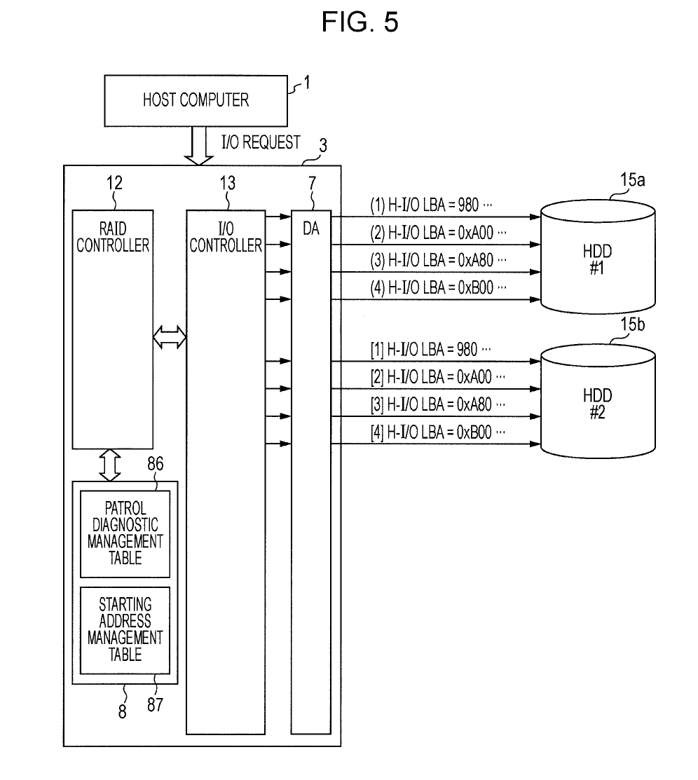

FIG. 5 is a first explanation of a patrol diagnosis during I/O processing and schematically illustrates controlling when I/O processing in which patrol diagnosis is requested by the host computer 1 (patrol diagnosis during I/O processing) is executed as a trigger. Patrol diagnosis during I/O processing is executed as a routine independent of the abovementioned regular patrol diagnosis.

The RAID controller 12 receives from the host computer an I/O request to instruct data reproduction. The RAID controller 12 sends an execution instruction requesting reproduction to the I/O controller 13 in response to the I/O request (reproduction request). In FIG. 5, the I/O controller 13 prepares host request read commands (H-I/O commands) (1) to (4) for the HDD #1 that is the memory device 15a in response to the reproduction request. The I/O controller 13 also prepares H-I/O commands [1] to [4] for the HDD #2 that is the memory device 15b and provides redundancy for the HDD #1.

The RAID controller 12 then refers to the patrol diagnosis management table 86 to check whether or not the patrol diagnosis has been completed for patrol diagnosis area (area 2: LBA 0x800 to LBA 0xFFF) containing the range of the access target I/O request LBAs (LBA 980 to 0xB7F).

If the patrol diagnosis is uncompleted, the RAID controller 12 instructs the I/O controller 13 to execute the patrol diagnosis of the area 2 (LBA 0x800 to LBA 0xFFF) containing the I/O request LBA range (LBA 980 to 0xB7F).

Since data reproduction processing is executed on the I/O request LBA range (LBA 980 to 0xB7F), the patrol diagnosis may be executed using data acquired from this reproduction processing.

As a result, the I/O controller 13 may exclude the I/O request LBA range (LBA 980 to 0xB7F) and, as explained below, execute a patrol diagnosis on the LBA range (LBA 0x800 to LBA 0x97F) before the I/O request LBA range and the LBA range (LBA 0xB80 to LBA 0xFFF) after the I/O request LBA range. Therefore, as explained below, the patrol diagnosis may be executed on all the data regions of the area 2 (LBA 0x800 to LBA 0xFFF).

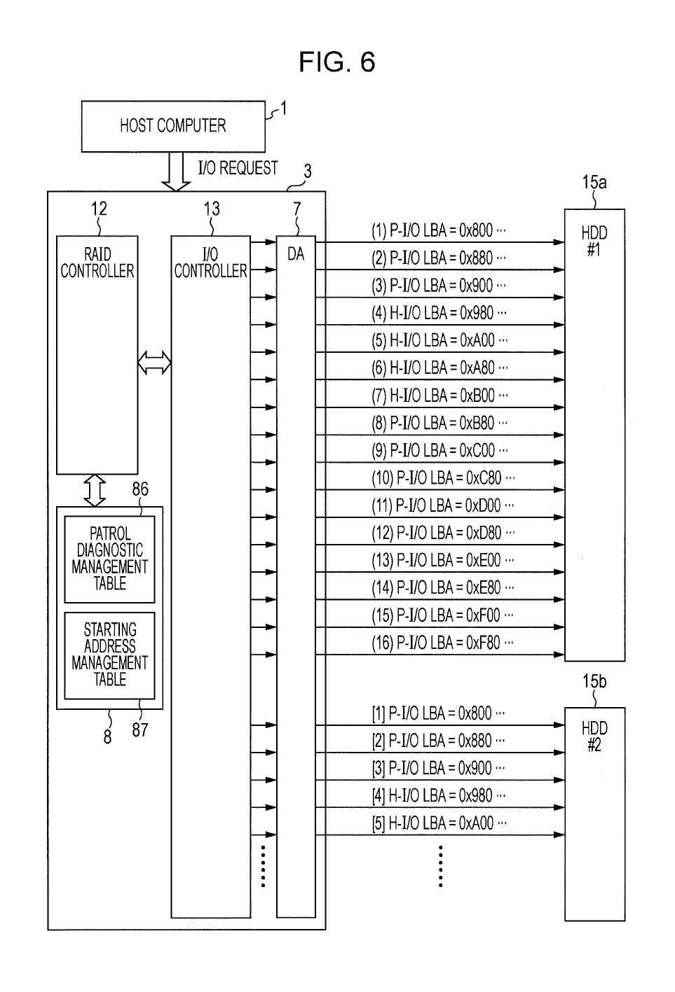

FIG. 6 is a second explanation of a patrol diagnosis during I/O processing. As illustrated in FIG. 6, the I/O controller 13 creates twelve second diagnosis commands (diagnostic read commands: P-I/O commands) to instruct the diagnostic reproduction on the remaining LBA ranges outside of the I/O request LBA range in the patrol diagnosis area (area 2).

Specifically, the I/O controller 13 creates twelve P-I/O commands (1) to (3) and (8) to (16) for the LBA ranges (LBA 0x800 to LBA 0x97F) before the I/O request LBA range and for the LBA ranges (LBA 0xB80 to LBA 0xFFF) after the I/O request range. The I/O controller 13 similarly creates P-I/O commands [1] to [3] and [8] to [16] for the HDD #2 that is the memory device 15b providing redundancy.

The I/O controller 13 sorts the four H-I/O commands illustrated in FIG. 5, and the twelve P-I/O commands illustrated in FIG. 6 in order to match the ascending order of the addresses to which the commands are specified. The I/O controller 13 then creates sixteen commands (1) to (16) and [1] to [16] for the area 2. The I/O controller 13 then sequentially issues the commands (1) to (16) and [1] to [16] to the HDD #1 and the HDD #2 respectively at a certain timing.

The number of addresses that may be specified with one command is determined beforehand according to device interface standards. Therefore, the number of commands changes according to the number of addresses and the sizes of the patrol diagnosis areas, and therefore is not limited to the number indicated in the present embodiment.

Moreover, dummy data of the unrecorded data storage regions is recorded beforehand. Therefore, errors may be reliably detected when the diagnostic reproduction is executed due to the first and second diagnosis commands.

The HDDs #1 and #4 include a queuing function and a reordering function. The queuing function is a function to insert commands in a waiting queue when the HDD receives a subsequent command before the present command is completed. The reordering function is a function to reorder the commands inserted in the queue to allow the HDD to efficiently conduct a seek operation so that data recording and reproducing and the like is conducted in order.

Therefore, controllers in the HDD #1 and HDD #2 use the abovementioned queuing function to receive the sixteen commands and insert the commands into the queue. The controllers of the HDDs #1 and #2 use the reordering function to rearrange the logical block addresses specified by the commands accumulated in the queue in order.

Specifically, the HDD #1 and the HDD #2 rearrange the logical block addresses to be processed so that transfer waiting and magnetic head movements occur as infrequently as possible.

Here, the logical block addresses specified respectively by the sixteen commands are arranged consecutively in ascending order. Moreover, the tracks of the hard disk media are set as a plurality of physical sectors. The logical block addresses are pre-assigned to physical sectors around the tracks in order of the track-following direction of the magnetic heads.

Furthermore, the logical block addresses are pre-assigned in order from the inside to the outside of the tracks or from the outside to the inside of the tracks in the plurality of physical sectors of the tracks. Therefore, the controllers of the HDD #1 and the HDD #2 are able to make the magnetic heads consecutively follow in order the physical sectors associated with the logical block addresses by processing the logical block addresses in order to conduct data reproduction.

Specifically, the HDD #1 and the HDD #2 may execute by sequential accessing the diagnostic reproduction due to the reproduction and diagnosis processing initiated by the I/O processing. When the time intervals between issuing the commands are long, the HDD processing finishes earlier and the commands are not queued. Therefore, the issue interval is predetermined to allow the queuing function to be used for each HDD and to fall within the time period previously set for each HDD.

Therefore, the HDD #1 and the HDD #2 may use the queuing function and the reordering function to execute processing of the sixteen commands by sequential accessing. As a result, the patrol diagnosis may be executed while processing data reproduction (I/O processing).

The patrol diagnosis opportunities can be increased for the storage devices by establishing sequential accessing for the data reproduction processing (I/O processing) and the diagnosis processing and by using the acquired data. Therefore, patrol diagnoses may be executed without affecting the I/O processing accessibility (access speed).

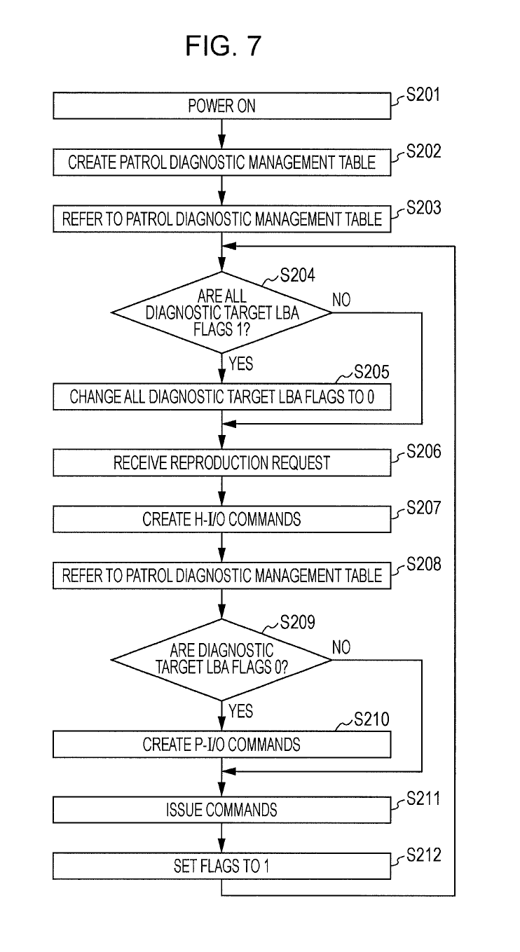

FIG. 7 illustrates a control flow of a patrol diagnosis during I/O processing. In S201, the power is turned on in each of the HDDs #1 to #4 that are the respective memory devices 15a to 15d. In S202, the RAID controller 12 creates the patrol diagnosis management table 86. In S203, the RAID controller 12 refers to the patrol diagnosis management table 86.

In S204, the RAID controller 12 determines whether or not the flags that indicate the patrol diagnosis execution conditions for all the logical block addresses (all diagnosis target LBAs) of the access target and diagnosis target HDDs are all “1” (executed).

If the flags all indicate “1” (S204: Yes), the patrol diagnoses of all the logical block addresses in the diagnosis targets are completed and the RAID controller 12 changes the flags of all the diagnosis target LBAs to “0” (uncompleted) in S205. If a flag indicates that the patrol diagnosis has not been completed (S204: No), the processing advances to S206.

In S206, the RAID controller 12 receives from the host computer 1 an I/O request (reproduction request) to instruct data reproduction. In S207, the I/O controller 13 receives the instruction from the RAID controller 12 and creates host request read commands (H-I/O commands) corresponding to the reproduction request.

In S208, the RAID controller 12 refers to the patrol diagnosis management table 86. If the flags of the logical block addresses to be diagnosed indicate “0” (uncompleted) in the patrol diagnosis management table 86 (S209: Yes), the RAID controller 12 further creates, in S210, diagnosis read commands (P-I/O commands) for conducting patrol diagnosis.

If no flags indicate “0” (S209: No), the processing advances to S211. If the patrol diagnosis is completed (the flags are “1”), the patrol diagnosis during I/O processing is not executed on the logical block addresses to be diagnosed. Specifically, if the patrol diagnoses are executed in the regular patrol diagnosis or the previous patrol diagnosis during I/O processing, the patrol diagnosis is not executed and only the I/O processing is carried out. Therefore, the patrol diagnosis may be conducted efficiently.

In S210, the I/O controller 13 consecutively arranges the H-I/O commands and the P-I/O commands to allow for sequential accessing. In S211, the arranged commands are issued in order to the HDDs to be accessed and diagnosed at the certain timing. In S212, the RAID controller 12 sets the flags of the diagnosed logical block addresses to “1” (executed) in the patrol diagnosis management table 86, and the processing returns to S203.

Therefore, patrol diagnosis opportunities may be increased for the storage devices by establishing sequential accessing for the data reproduction processing and the diagnosis processing and by using the acquired data.

Consequently, according to the present embodiment, errors in the storage devices may be quickly detected due to the increase in the patrol diagnosis opportunities. Moreover, error recovery and rebuilding reliability are improved and thus the reliability of the storage devices may be improved.

Additionally, as explained with reference to FIG. 6, patrol diagnoses may be similarly executed on storage devices that provide redundancy with the storage devices subject to accessing and diagnoses, by adopting the control flow described in FIG. 7. Therefore, according to the present embodiment, patrol diagnosis opportunities on a plurality of redundant storage devices may also be increased.

Consequently, according to the present embodiment, errors in the plurality of redundant storage devices may be quickly detected. Moreover, error recovery and rebuilding reliability are improved and thus the reliability of the storage devices may be improved.

However, the present disclosure is not limited to the above embodiment. Various embodiments may be combined while maintaining consistency. The above embodiment is merely an example and has a substantially similar configuration to the technical ideas described in the claims of the present disclosure. Configurations that achieve similar effects are included within the technical scope of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control device comprising:
an interface for a host computer and a memory device; and
a control unit that creates a read command that causes the memory device to reproduce data at an access target address, and creates a first diagnosis command that causes the memory device to conduct a diagnostic reproduction at an address subsequent to the access target address, according to the request received from the host computer, sequentially issues the read command and the first diagnosis command to cause the memory devices to execute sequential accessing and conducts a diagnosis to confirm the normality of the memory device.

2. The storage control device according to claim 1, wherein the first diagnosis command is a command that cause the memory device to conduct the diagnostic reproduction on one or more consecutive addresses before or after the access target address.

3. The storage control device according to claim 1, wherein a data storage region of the memory device is a data storage region in which a plurality of diagnosis areas are previously set and the plurality of diagnosis areas are specified by a plurality of consecutive addresses; and
the first diagnosis command is a command that causes the memory device to conduct the diagnostic reproduction on another address other than the access target address in the diagnosis area to which the access target address belongs among the plurality of patrol diagnosis areas.

4. The storage control device according to claim 1, wherein, when the patrol diagnosis is not completed, the control unit refers to a patrol diagnosis management table in which are recorded execution conditions of the patrol diagnosis corresponding to addresses of the memory device to create the first diagnosis command.

5. The storage control device according to claim 1, wherein the control unit issues to the memory device a second diagnosis command that is different from the first diagnosis command and that causes the memory device to conduct a diagnostic reproduction in an address order from a starting address of the memory device at certain time periods.

6. The storage control device according to claim 1, wherein the memory device is a plurality of redundant memory devices and the read command and the first and second diagnosis commands are issued to the plurality of memory devices.

7. A storage device comprising:
a memory device that conducts data recording or reproduction in a memory device according to a request from a host computer; and
a storage control device that conducts recording control and reproduction control of data in a memory device included in a storage device, and conducts a patrol diagnosis to reproduce data recorded on the memory device to confirm the normality of the memory device;
wherein the storage control device includes:
an interface that receives the request from the host computer; and
a control unit that creates a read command that causes the memory device to reproduce data at an access target address, and creates a diagnosis command to cause the memory device to conduct a diagnostic reproduction at an address subsequent to the access target address, according to the request received from the host computer, and sequentially issues the read command and the diagnosis command to cause the memory device to execute sequential accessing.

8. A diagnosis method for a storage device, the diagnosis method comprising:
receiving the request from a host computer;
creating a read command that causes a memory device to reproduce data at an access target address, and creating a diagnosis command to cause the memory device to conduct a diagnostic reproduction at an address subsequent to the access target address, according to the request received from the host computer,
issuing the read command and the diagnosis command to the memory device to cause the memory device to conduct sequential accessing,
outputting an error of data reproduced by the read command and the diagnosis command, and
conducting a diagnosis to confirm the normality of the memory device.
